(19) United States
(12) Patent Application Publication
(10) Pub. No.: US 2020/0051370 A1
(43) Pub. Date: Feb. 13, 2020

(54) DOUBLE-RANDOMISED VIRTUAL OBJECT GENERATION

(71) Applicant: Atlas Gaming Technologies Pty Ltd., Port Melbourne (AU)

(72) Inventor: Zenja Solaja, Port Melbourne (AU)

(73) Assignee: Atlas Gaming Technologies Pty Ltd., Port Melbourne (AU)

(21) Appl. No.: 16/537,773

(22) Filed: Aug. 12, 2019

(30) Foreign Application Priority Data
Aug. 13, 2018 (AU) 2018902960

(51) Int. Cl. G07F 17/32; G09G 5/37; G09G 5/38; G06T 13/20; G07F 17/34

(52) U.S. Cl. CPC G07F 17/3211; G09G 5/37; G09G 5/38; G09G 2354/00; G07F 17/3258; G07F 17/34; G06T 13/20

(57) ABSTRACT

Described embodiments generally relate to a method of double-randomised virtual object generation. The method comprises generating a pre-determined number of virtual pots; generating a pre-determined number of virtual objects, each virtual object allocated to one of the virtual pots and comprising a pre-determined number of unique faces; randomly selecting a pre-determined number of virtual objects from the virtual pots; for each randomly selected virtual object, randomly selecting a face of the virtual object; and presenting the randomly selected objects on a display, each randomly selected object being oriented to show its randomly selected face.

### CROSS-REFERENCE TO RELATED APPLICATION

The present application claims priority from Australian Provisional Patent Application No. 2018902960, filed Aug. 13, 2018, the disclosure of which is hereby incorporated herein by reference.

### TECHNICAL FIELD

Described embodiments generally relate to methods and systems for double-randomised virtual object generation. In particular, embodiments relate to gaming machines configured to provide double-randomised virtual object generation.

### BACKGROUND

Gaming machines commonly use one or more virtual objects to display a randomly selected set of symbols to a player. For example, many gaming machines will display a set of reels. Each reel may contain a number of symbols, with one or more of the symbols from each reel being displayed to the user at any one time. However, players may find that playing multiple games at a reel-style gaming machine can become monotonous after playing for a long duration.

It is desired to address or ameliorate one or more shortcomings or disadvantages associated with prior methods and systems for the generation of random symbols, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a method of double-randomised virtual object generation, the method comprising:
generating a pre-determined number of virtual pots;
generating a pre-determined number of virtual objects, each virtual object allocated to one of the virtual pots and comprising a pre-determined number of unique faces;
randomly selecting a pre-determined number of virtual objects from the virtual pots;
for each randomly selected virtual object, randomly selecting a face of the virtual object; and
presenting the randomly selected objects on a display, each randomly selected object being oriented to show its randomly selected face.

Some embodiments further comprise:
comparing the randomly selected faces with a pay table; and
based on the comparison, determining whether a winning event has occurred.

According to some embodiments, the randomly selected objects are presented on the display in a grid formation of rows and columns. In some embodiments, randomly selecting a pre-determined number of virtual objects comprises selecting a non-prime number of virtual objects and assigning each virtual object a predetermined position in the grid. In some embodiments, randomly selecting a pre-determined number of virtual objects comprises selecting fifteen virtual objects and assigning each virtual object a predetermined position in the grid, the grid comprising five columns and three rows.

In some embodiments, at least one randomly selected object is shown to move into a predetermined position on the display. According to some embodiments, the at least one randomly selected object is shown to bounce against at least one virtual barrier as the object moves into the predetermined position on the display. In some embodiments, the at least one randomly selected object is shown to bounce against at least one virtual barrier extending along a horizontal plane and at least one virtual barrier extending along a vertical plane as the object moves into the predetermined position on the display. In some embodiments, the vertical plane is parallel to the plane defined by the display.

According to some embodiments, the at least one object rotates as the object moves into the predetermined position on the display. In some embodiments, an axis of rotation of the at least one object changes as the object moves into the predetermined position on the display.

According to some embodiments, at least one randomly selected object is subject to an increasing virtual interpolation force as the object moves toward the predetermined position on the display, wherein the interpolation force causes the object to rotate into a position whereby the randomly selected face is presented toward a viewer of the display when the object moves into the predetermined position on the display.

In some embodiments, each randomly selected object has six faces. In some embodiments, each of the randomly selected faces displays at least one of a letter, numeral, or image.

Some embodiments relate to a gaming machine comprising:
memory storing program code; and
a processor configured to access the memory and execute the program code;
wherein, when executing the program code, the processor is caused to perform the method of some other embodiments.

Some embodiments further comprise a credit input mechanism configured to accept credit from a user to initiate the performance of the method of some other embodiments. Some embodiments further comprise a payout mechanism configured to output credit to a user when a winning combination is determined.

Some embodiments relate to a method of controlling motion of a virtual object, the method comprising:
determining a desired final orientation for a virtual object;
positioning the virtual object at a pre-determined starting position;
applying a virtual force to the object to propel it toward a pre-determined finishing position;
applying an interpolation factor to the virtual object, the interpolation factor increasing over time, wherein the interpolation factor causes a pulling of the virtual object into the desired final orientation when the object reaches the pre-determined finishing position.

According to some embodiments, the virtual force causes a rotation of the virtual object. In some embodiments, an axis of rotation of the virtual object changes over time.

### BRIEF DESCRIPTION OF THE DRAWINGS

Embodiments are described in further detail below, by way of example and with reference to the accompanying drawings, in which:

FIG. 1 shows a perspective view of a gaming machine;

FIG. 2 shows a block diagram of a game logic circuitry of the gaming machine illustrated in FIG. 1;

FIG. 3 shows a block diagram of functional components of a gaming system incorporating gaming machines illustrated in FIG. 1;

FIG. 4A shows a diagram illustrating a double randomised virtual object generation process that may be performed by the gaming machine of FIG. 1;

FIG. 4B shows an example virtual object in an unwrapped configuration;

FIG. 5 shows a flowchart illustrating a method of executing a game on the gaming machine of FIG. 1;

FIG. 6 shows an example screenshot illustrating a plurality of virtual objects displayed during game play on the gaming machine of FIG. 1;

FIG. 7 shows a further example screenshot illustrating a plurality of virtual objects displayed during game play on the gaming machine of FIG. 1;

FIG. 8 shows an example screenshot illustrating a plurality of virtual objects displayed at the conclusion of a game play scenario on the gaming machine of FIG. 1;

FIG. 9 shows a diagrammatic view of the path of a virtual object within a virtual environment generated by the gaming machine of FIG. 1;

FIG. 10A shows a graph illustrating the application of interpolation factors over time to control movement of a virtual object generated by the gaming machine of FIG. 1; and

FIG. 10B shows a graph illustrating the application of a total interpolation factor over time to control movement of a virtual object generated by the gaming machine of FIG. 1.

### DETAILED DESCRIPTION

Described embodiments generally relate to methods and systems for double-randomised virtual object generation. In particular, embodiments relate to gaming machines configured to provide double-randomised virtual object generation.

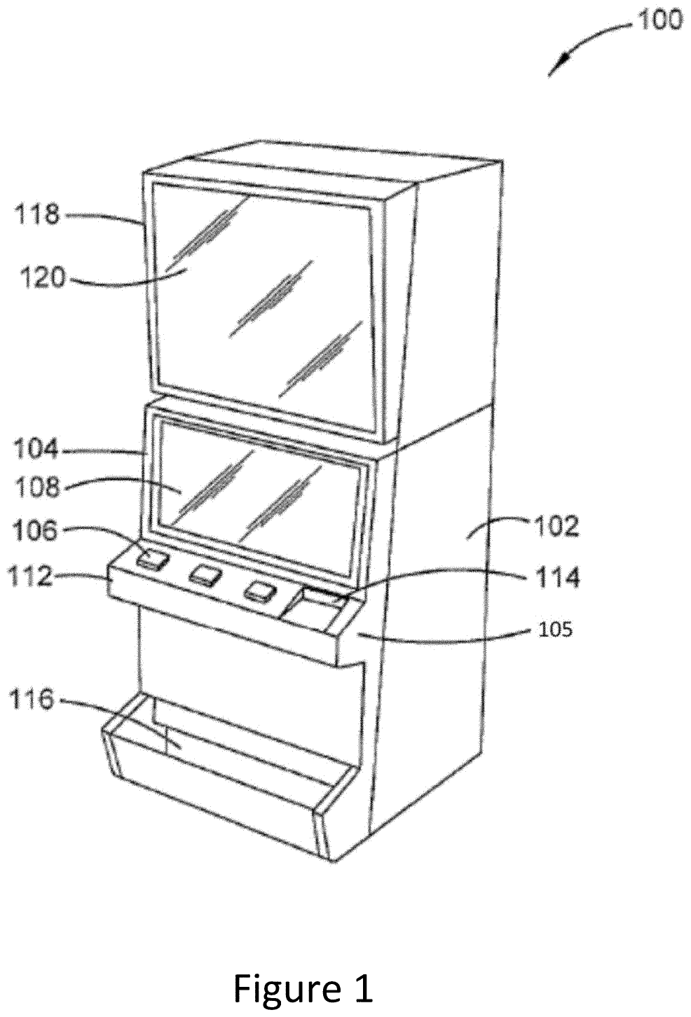

In FIG. 1, reference numeral 100 generally designates a stand-alone gaming system including a game. A stand-along gaming system may be a system which can operate by itself based on inputs received from a player and which requires no further interaction from other systems. Hereinafter, the stand-alone gaming system 100 will be referred to as a gaming machine 100.

The gaming machine 100 includes a console 102 which contains all or most components required to implement a game play whereby a player wins or loses a wager. Access to the interior components is by way of a hinged door 105. Moulded or otherwise affixed to the exterior of the console 102 is a display means in the form of at least one visual display unit 104 on which one or more games is played. The video display unit 104 may be implemented as a liquid crystal display, a plasma screen, as a cathode ray screen device or the like. According to some embodiments, visual display unit 104 may comprise a touch screen display. What is displayed on the visual display unit 104 will depend on what the intended goal of the unit is in relation to the player and any other potential participants in the gaming system.

According to some embodiments, gaming machine 100 may comprise more than one display means. For example, in the illustrated embodiment, gaming machine 100 includes a top box 118 on which secondary screen 120 is carried in the form of an electronic visual display unit. According to some embodiments, instead of a secondary screen 120, top box 118 may comprise other display means, which could include displays made from physical materials such as paper, plastic banners or posters. The secondary screen 120 or other display means may display generic information related to the machine or gaming system, or secondary screen 120 may display information specifically relating to a particular game to be played on the machine 100. Whilst the secondary screen 120 is shown as being carried on the top box 118, secondary screen 120 can also be positioned in or on the bottom panel of the door 105, or any other part of the gaming machine 100 visible to the player.

According to some embodiments, one or more of visual display unit 104 and secondary screen 120 may be configured to display 1920×1080 pixels resolution at a 60 Hz refresh rate. According to some embodiments, one or more of visual display unit 104 and secondary screen 120 may be flat. In some embodiments, one or more of visual display unit 104 and secondary screen 120 may be curved. One or more of visual display unit 104 and secondary screen 120 may be concavely curved along the horizontal axis so that the side edges of the screen curve toward a position in front of the gaming machine 100 where the player would normally be.

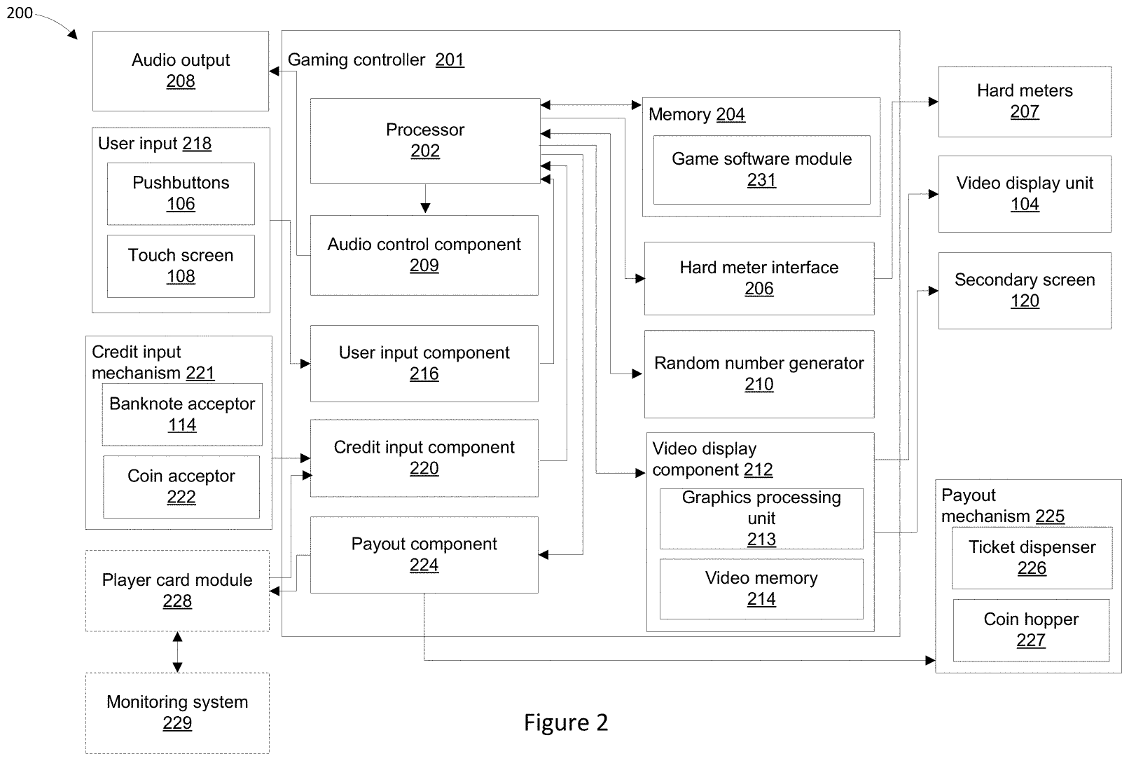

The gaming machine 100 includes user input 218 (shown in FIG. 2) configured to allow a player to interact via touch with the gaming machine 100. In this example, the user input is in the form of a combination of pushbuttons 106 and a touch screen 108 for enabling a player to play one or more games. The touch screen 108 comprises an electronic visual display that can detect the presence and location of a touch within the display area. According to some embodiments, touch screen 108 may be integrated into at least one of video display unit 104 and secondary display unit 120. The touch screen 108 may be used in between the end of a game and the start of a next game, for example for the player/user to access game information and/or do a limited amount of configuration, such as adjust screen brightness, volume or other functional aspects not affecting a game outcome.

The touch screen 108 may be used during the game play between the start of a game and the end of a game. According to some embodiments, a game is considered to have started once a wager is placed and considered complete once the wager has been lost or won. Pushbuttons 106 may include one or more buttons which are physically actuatable by a user. Functions of pushbuttons 106 may include: initiation of game play, credit output, gameplay selection, completion of gameplay etc. A midtrim 112 of the machine 100 houses the pushbuttons 106.

It should be appreciated that user input 218 may include any suitable device that enables the player to produce an input signal that is received by the processor. User input in the form of pushbuttons 106 and/or regions on touch screen 108 may include a one bet button, a max bet button, or a repeat-the-bet button. With a one bet button, for instance, the player places a bet by pushing the one bet button. The player may increase the bet by one credit each time the player pushes the one bet button.

The midtrim 112 also houses a credit input mechanism 221 (shown in FIG. 2), including a banknote acceptor 114, configured to accept banknotes and provide a player with a corresponding amount of credit. According to some embodiments, banknote acceptor 114 may also be configured to operate as a ticket-in-ticket-out device, accepting tickets representative of a credit amount. Such tickets may be printed by other machines located in a gaming venue. Banknote acceptor 114 may be configured to communicate with credit input component 220 via a specific protocol over a serial link, which may be a RS232 link, or similar. The credit input mechanism 221 may further include a coin acceptor 222 (shown in FIG. 2), configured to accept coins and provide a player with a corresponding amount of credit. According to some embodiments, gaming machine 100 may optionally include a player card module 228 (shown in FIG. 2), which may act as a credit input mechanism in some embodiments. Player card module 228 may comprise, a card and/or ticket reader, a magnetic reading head for reading a magnetic stripe card, an electronic reader for a proximity card, a near field communications reader or any other form of electronic, wireless or contact that can input credit to the gaming machine. According to some embodiments, player card module 228 may replace credit input mechanism 221 in a gaming machine 100.

A payout mechanism 225 is mounted beneath the console 102 and is provided for cash payouts from the machine 100 to the player. According to some embodiments, payout mechanism 225 comprises a coin hopper 227 which dispenses coins or tokens equal to the amount of credit currently on the machine, into a coin tray 116. Aside from the coin hopper 227 and coin tray 116, the payout mechanism 225 may also include one or more of: a ticket dispenser 226 for issuing a ticket dispensed by a printer which the user can redeem for cash; a note dispenser; a near field communications transmitter; or other means to enable wireless or remote credit transfer. A ticket dispensed by ticket dispenser 226 may be able to be redeemed by a player at a cashier station at the gaming venue. According to some embodiments, ticket dispenser 226 may be configured to communicate with payout component 224 via a serial or USB interface. It should be appreciated that any suitable payout mechanisms, such as funding to the player's electronically recordable identification card or smart card, may be implemented in accordance with the gaming machine 100 disclosed herein. According to some embodiments, player card module 228 may act as a payout mechanism. According to some embodiments, player card module 228 may replace credit input mechanism 221 in a gaming machine 100.

The gaming machine 100 further includes audio output 208 (shown in FIG. 2) to provide auditory feedback to the player of the gaming machine 100. According to some embodiments, audio output 208 may comprise one or more speakers, subwoofers, earphones, or other audio output mechanisms. In some embodiments, audio output 208 may provide a stereo audio output. According to some embodiments, audio output 208 may comprise two speakers and a subwoofer.

During game play on gaming machine 100, a player may: read game play instructions via video display unit 104 and/or secondary screen 120; insert credit into gaming machine 100 via credit input mechanism 221; initiate a game or series of games by interacting with user input 218 via pushbuttons 106 and/or touch screen 108; and observe the outcome of the game via video display unit 104, secondary screen 120 and/or audio output 208. A player may be able to collect any remaining or accumulated credit at any time via payout mechanism 225.

Referring to FIG. 2 of the drawings, game logic circuitry and componentry 200 is illustrated. The game logic circuitry and componentry 200 includes a gaming controller 201. The gaming controller 201 may be disposed in a logic cage (not shown), for example. The logic cage may include a box-like mechanical cage structure that has slots to guide logic cards into the proper location for electronically plugging into a backplane mounted at the rear of the cage structure. The backplane may include connectors for accepting mating connectors on the logic cards. The logic cage and associated cards may serve to at least partly define the functional capabilities of the game controller 201 and form one of the basic components of the gaming machine 100. The logic cage may be securely housed within the cabinet of the gaming machine 100. Circuitry and componentry 200 may be configured to combine features of an industrial computer, such as ruggedness and reliability, with high processing power and 3D rendering capability sufficient to display entertaining games.

Central to the logic cage is at least one processor 202 which may act as a central processing unit and may include a processor, a microcontroller-based platform, a suitable integrated circuit, or one or more application-specific integrated circuits (ASICs). Processor 202 may include more than one processing chip or component, but the singular term processor 202 is used herein for convenience. Processor 202 may be configured to be powerful enough to be able to perform floating point calculations for a physics engine, and 3D rendering calculations to allow for the display of 3D animations. According to some embodiments, processor 202 may comprise at least a dual core CPU capable of running at at least 1.6 GHz. The processor 202 is in communication with or operable to access or to exchange signals with memory 204. Memory 204 may comprise RAM, ROM, a non-volatile memory in the form of a compact flash, battery backed up memory, or other memory devices. RAM may include DRAM, non-volatile RAM (NVRAM), magnetic RAM (MRAM), ferroelectric RAM (FeRAM), and other forms as commonly understood in the gaming industry.

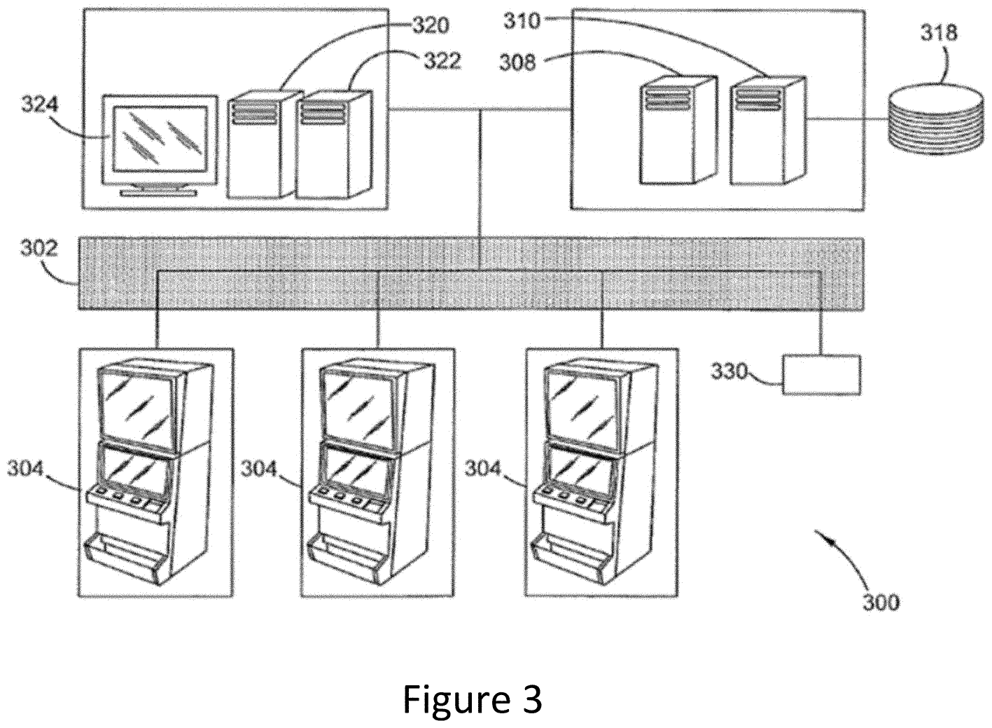

Memory 204 stores game software module 231. Game software module 231 comprises one or more executable code modules accessible by processor 202. Game software module 231 may store game play logic rules and credit processing rules, that govern when and how much credit a player should receive based on the outcome of a game, as well as processing credit input by the player. Game software module 231 may also store game graphics code and resources that allow processor 202 to cause graphics to be generated and displayed via video display component 212, and audio processing instructions that allow processor 202 to instruct audio control component 209 to generate audio data. Game software module 231 may further store input/output processing software to allow processor 202 to facilitate communications between gaming controller 201 and user inputs 218, as well as outputs 208, 104, and 120. According to some embodiments, game software module 231 may also store communications software that allows gaming machine 100 to communicate with external devices, as described in further detail below with reference to FIG. 3. According to some embodiments, memory 204 may comprise at least 4 GB of DRAM, to allow for game software module 231 to be stored on DRAM.

According to some embodiments, gaming machine 100 may comprise safety intrusion monitoring and security. This may comprise one or more sensors on the body and inside gaming machine 100, to detect unauthorised tampering with gaming machine 100. Gaming machine 100 may also comprise power failure handling and recovery features, which may include back-up battery systems and battery-backed up recovery memory devices that preserve data should a power down period occur where gaming machine 100 loses power. According to some embodiments, gaming machine 100 may comprise at least 2 MB of battery backed up storage. Gaming machine 100 may also comprise a logging microprocessor operating on battery power to perform intrusion monitoring functions during a power down period.

Processor 202 may also be in communication with audio output 208 via an audio control module 209. The audio control module 209 may have its own digital signal processor, analogue to digital converters, amplifiers and other circuitry necessary to broadcast the output from the speakers.

The processor 202 runs executable code residing in game software module 231 of memory 204 that facilitates play of a game by a player through the display devices 104 and 120, and/or pushbuttons 106 and touchscreen 108 mounted in display devices 104 and 120. Processor 202 may communicate with user input 218 via user input component 216, and with video display unit 104 and secondary screen 102 via video display component 212. Video display component 212 may comprise a graphics processing unit (GPU) 213 to allow graphics to be generated, as well as video memory 214 configured to store data for display. GPU 213 may comprise a 3D programing application programming interface (API), which may be an OpenGL, Vulcan, or DirectX API, for example. GPU 213 is preferably powerful enough to allow for graphics to be generated on-the-fly and displayed on video display unit 104 and/or secondary screen 120. Where video display unit 104 and secondary screen 120 have a resolution of 1920×1080 each, for example, GPU 213 may be configured to be powerful enough to perform real-time rendering of a resolution of 1920×2160 (combined) at a refresh rate of 60Hz. According to some embodiments, the speed of rendering performed by GPU 213 may be at least 100 frames per second. According to some embodiments, GPU 213 may be configured to support BC7 compression.

Data used by GPU 213 may be stored in video memory 214, which may comprise a form of DRAM, such as video random access memory (VRAM). VRAM may be used in some embodiments as VRAM may be faster than DRAM, although in some embodiments DRAM may also be used as VRAM. According to some embodiments, video memory 214 may comprise at least 1 GB of VRAM.

The processor 202 may receive input signals from user input 218 and drive the screen of video display unit 104 and/or secondary screen 120

Processor 202 may also receive input signal pulses from credit input component 220 and payout component 224 to determine whether or not a player has provided sufficient credit from either payment device 114 or 222 to commence playing, and to instruct payout component 224 to dispense payment to a player. Credit input component 220 and payout component 224 may communicate with credit input mechanism 221 and payout mechanism 225 via an electrical signal interface.

Metering information may be stored in hard meters 207, which may be read and modified by processor 202 via hard meter interface 206. The values in hard meters 207 are only ever incremented, and cannot be reset or decremented. The only way to alter the values stored is by running the executable code stored in game software module 231, which is executed by processor 202, to increment the values stored. Values stored may include total number of games played on the machine, and total amount of credit input into the machine, for example. The game software module 231 contains the rules of the game, the sequence of gameplay, communicates with external systems, monitors peripheral equipment, maintains integrity of the software code, etc. The processor 202 continually checks for error conditions.

According to some embodiments, processor 202 may further be in communication with a random number generator 210, to generate random numbers as required to implement one or more games of chance. Random number generator 210 may be configured to include cryptographic hashes to allow for cryptographic random number generation.

In one embodiment, gaming machine 100 may comprise a player card module 228, allowing a player to insert an identification card into a card reader (not shown) as a way of inserting and receiving credit. The player's credit amount may be stored on the card, or may be linked to data stored on the card. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming machine 100. Player card module 228 may be in communication with a monitoring system 229 to verify cards inserted into player card module 228. Monitoring system 229 may store identification card numbers along with data associated with the card such as player identification, credit totals, and/or other relevant information. According to some embodiments, data stored on monitoring system 229 may be used where a player loses or damages their card.

FIG. 3 shows a gaming system 300 in accordance with an alternative embodiment. The gaming system 300 includes a network 302, which for example may be an Ethernet network. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random generator engine. Alternatively, a separate random number generator server could be provided. Further, persons skilled in the art will appreciate that a plurality of game servers could be provided to run different games or a single game server may run a plurality of different games as required by the terminals.

Gaming machine 100 and/or gaming system 300 may be configured to provide double-randomised virtual object generation. In particular, gaming machine 100 and/or gaming system 300 may be configured to present a game involving double-randomised virtual object generation. While the following description could apply to either a gaming machine 100 or a gaming system 300, the description has been written to refer only to gaming machine 100 for simplicity.

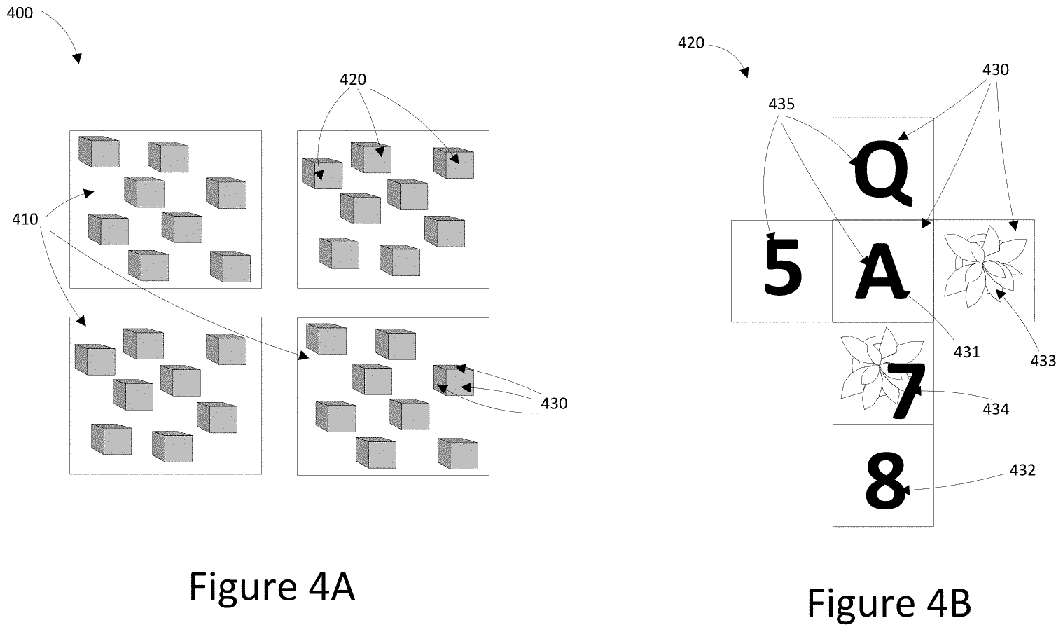

FIGS. 4A and 4B are diagrammatic representations of a double randomisation process as performed by gaming machine 100. FIG. 4A shows a diagram 400 of a plurality of virtual pots 410. Each virtual pot 410 contains a plurality of virtual objects 420. Each object 420 comprises a pre-determined number of faces 430. For example, in the illustrated embodiment, each object 420 comprises six faces 430. FIG. 4B shows an “unwrapped” object 420 showing each of the six faces 430. According to some embodiments, virtual objects 420 may comprise 4, 5, 7, 8, 9, 10, or another predetermined number of faces 430. According to some embodiments, each object 420 comprises the same number of faces 430. According to some embodiments, each object 420 in a given pot 410 contains the same number of faces 430, but different pots 410 may contain objects 420 with different numbers of faces 430. In some embodiments, objects 420 within pots 410 may contain different numbers of faces 430.

Each face 430 displays a symbol 435. According to some embodiments, symbols 435 may be selected from a limited number of possible symbols 435 stored in memory 204. Symbols 435 may comprise letters 431, numbers 432, images 433, or a combination 434 of letters, numbers and/or images. According to some embodiments, symbols 435 are randomly distributed among faces 430. According to some embodiments, symbols 435 may be weighted such that there are more of some symbols 435 in the pool than others. In this way, some symbols 435 may appear more often than others on faces 430.

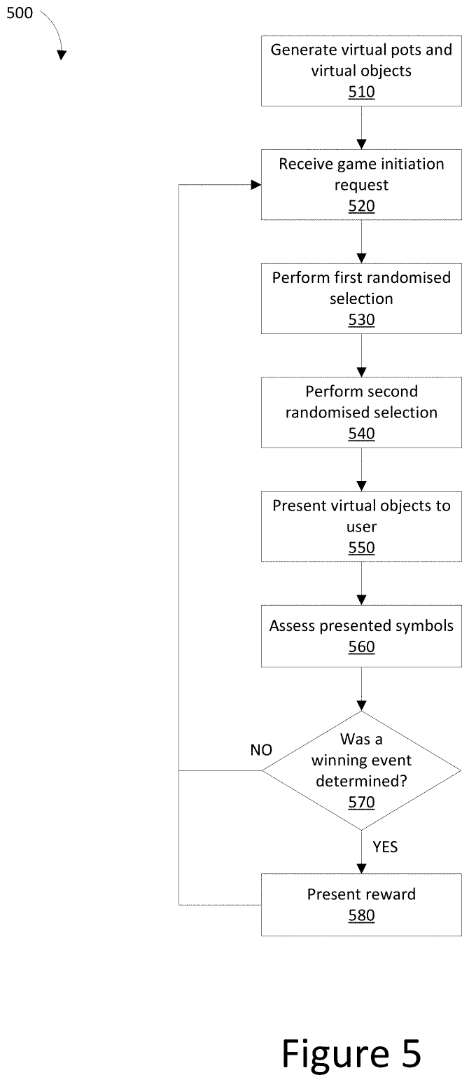

During gameplay, gaming machine 100 randomly selects a pre-determined number of objects 420 from each pot 410. Once selected, gaming machine 100 further randomly selects a face 430 for each selected object 420, the face displaying a symbol 435. The selected faces 430 and symbols 435 are then presented to a user as described below with reference to FIGS. 5 to 10B.

FIG. 5 shows a flowchart illustrating a method 500 executable by processor 202 of gaming machine 100 to present a game involving double-randomised virtual object generation.

At step 510, processor 202 generates a number of virtual pots 410 and virtual objects 420 as described above with reference to FIG. 4A, with virtual objects 420 displaying randomly selected symbols 435 on faces 430 as shown in FIG. 4B. According to some embodiments, the number of virtual pots 410 and/or the number of virtual objects 420 may be a predetermined number stored in memory 204 of gaming machine 100. According to some embodiments, the number of pots 410 and/or objects 420 may be generated in real-time, either randomly by random number generator 210 or based on one or more factors such as the game type, game history, or other factors.

At step 520, processor 202 receives a game initiation request entered by a user via user input 218 and transmitted to processor 202 via user input component 216. According to some embodiments, the game initiation request may comprise a bet amount. According to some embodiments, the game initiation request may further comprise a play line selection.

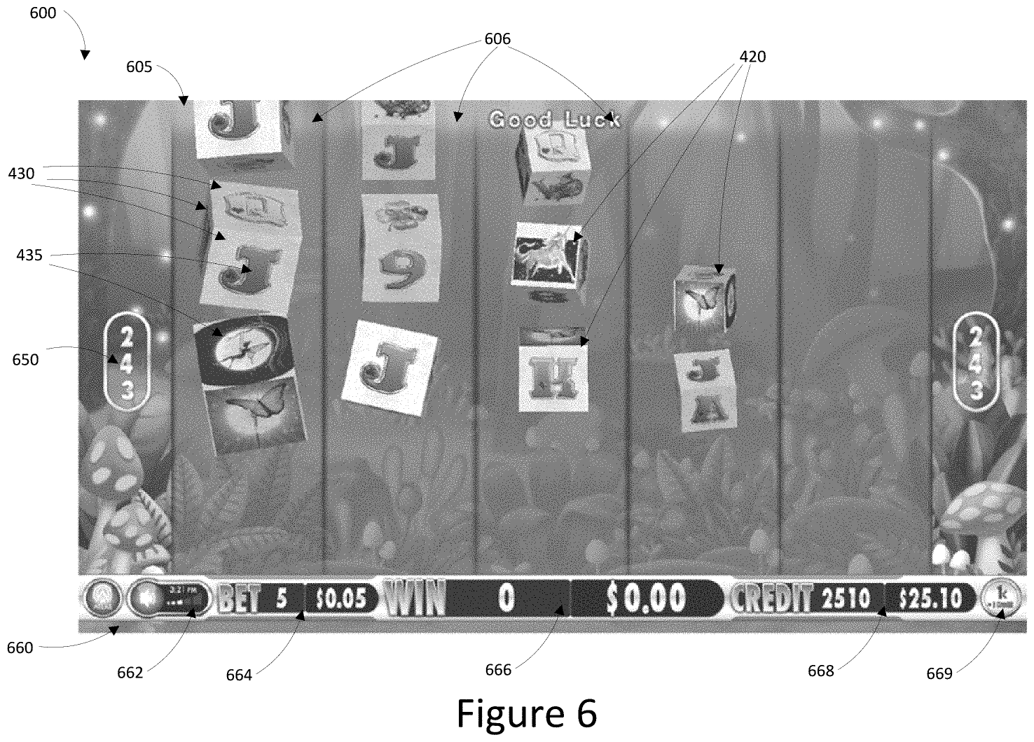

At step 530, processor 202 initiates a game by performing a first randomised selection. Specifically, processor 202 communicates with random number generator 210 to cause a random selection of a predetermined number of virtual objects 420 from virtual pots 410. According to some embodiments, 15 virtual objects 420 may be selected. According to some embodiments, 3, 9, 12, 16, 20, or another number of virtual objects 420 may be selected. According to some embodiments, the number of virtual objects 420 selected may be any non-prime number, to allow virtual objects 420 to be arranged in a grid, as described below with reference to FIGS. 6 to 8. Processor 202 may further allocate each object 420 a screen position, which may be within a grid or another arrangement.

At step 540, processor 202 performs a second randomised selection, by communicating with random number generator 210 to cause one face 430 of each object 420 to be randomly selected.

At step 550, processor 202 presents objects 420 to the user via an animation displayed on video display unit 104 via video display component 212. According to some embodiments, processor 202 may present objects 420 by virtually rolling or tumbling them toward the user within a virtual environment, to land with the selected face 430 being shown to the user. This is described in further detail below with reference to FIGS. 6 to 10B.

At step 560, processor 202 assesses the symbols 435 displayed on selected faces 430. Processor 202 determines whether a winning combination of symbols 435 has been generated at step 570. According to some embodiments, processor 202 may do this by comparing the displayed symbols 435 with symbols and/or symbol combinations listed in a pay table stored in memory 204.

If a winning event is determined to have occurred, at step 580, processor 202 may cause a reward to be awarded to the player via payout mechanism 225 by communicating the reward amount to payout component 224.

If no winning event is determined to have occurred, or after the reward has been awarded to the player at step 570, processor 202 causes method 500 to return to step 520 and awaits a further game initiation request.

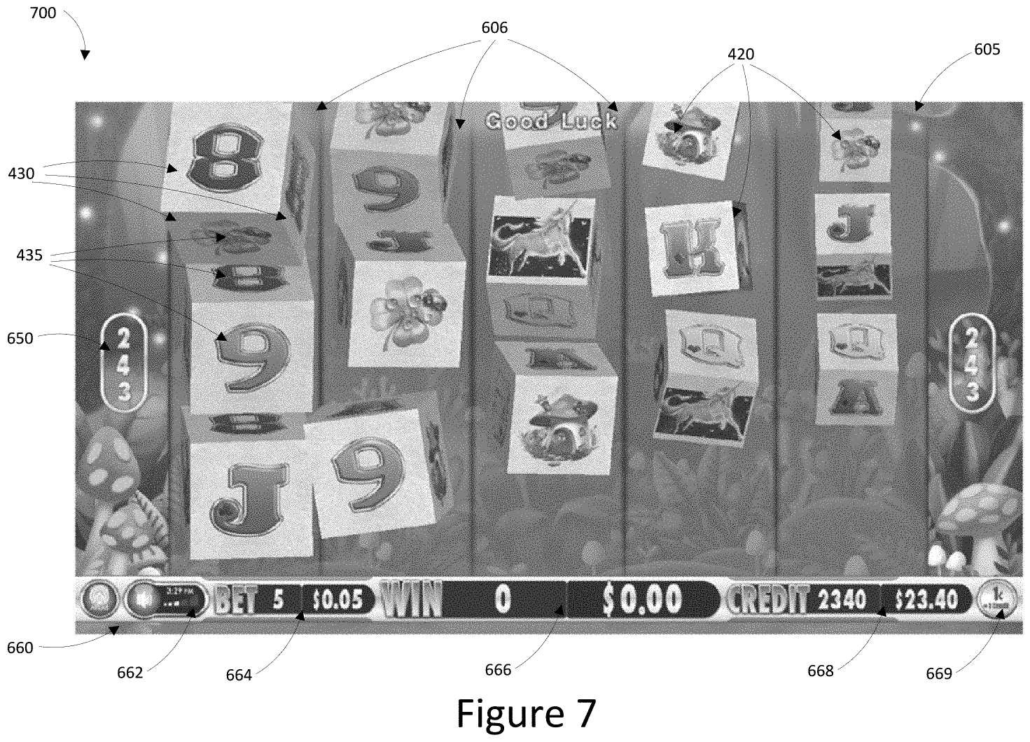

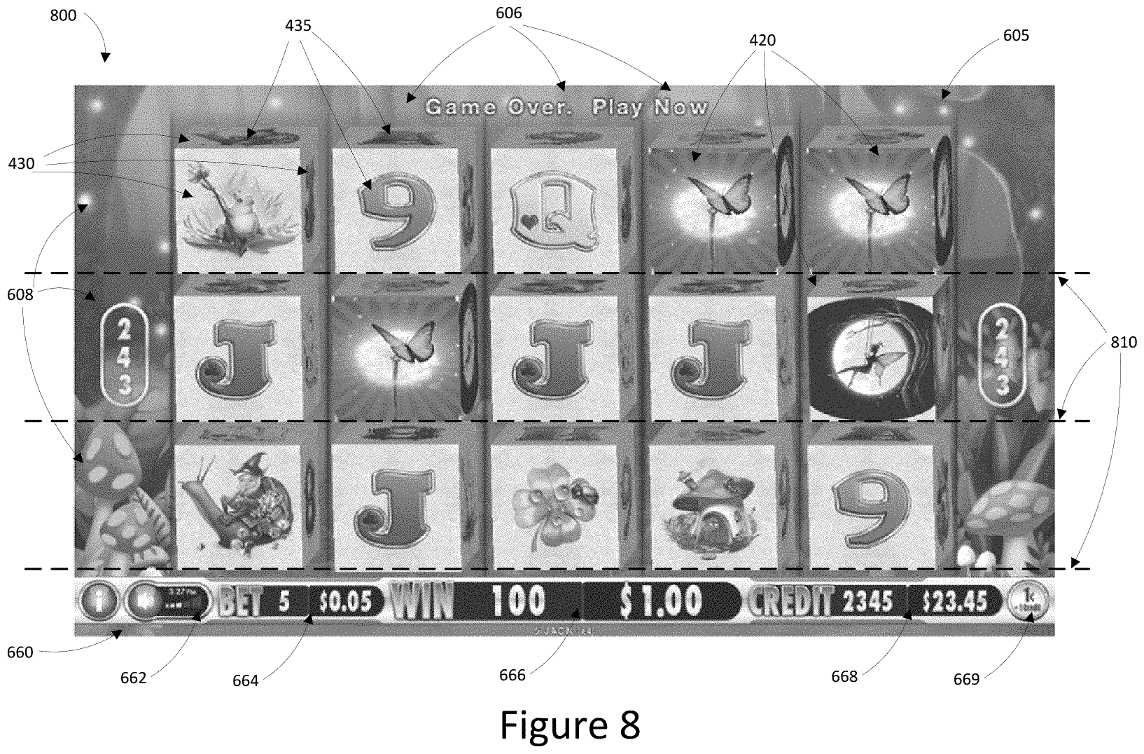

FIGS. 6, 7 and 8 show example screenshots taken during an animation that may be displayed on video display unit 104 during execution of step 550 of method 500, as described above with reference to FIG. 5. FIG. 6 shows a screenshot 600 taken at the start of an animation sequence, FIG. 7 shows a screenshot 700 taken in the middle of an animation sequence, and FIG. 8 shows a screenshot 800 taken at the end of an animation sequence.

In each of the screenshots, a game area 605 is shown. Game area 605 is divided into a number of columns 606. Game area 605 is also divided into a number of rows 608, as shown in FIG. 8. Rows 608 are divided by virtual shelves 810, as shown in FIG. 8, which may be invisible to the user. In the illustrated embodiment, game area 605 comprises 5 columns 606 and 3 rows 608. However, in some embodiments game area 605 may be divided into 1, 2, 3, 4, 5, or more rows 606. In some embodiments, game area 605 may be divided into 1, 2, 3, 4, 5, or more columns 608.

A plurality of virtual objects 420 are illustrated being rolled or tumbled into positions in columns 606 and rows 608. Virtual objects 420 comprise faces 430 displaying symbols 435. FIG. 6 shows virtual objects 420 at the start of a roll, FIG. 7 shows objects 420 in the middle of a roll, and FIG. 8 shows virtual objects 420 at the end of a roll, positioned in their locations in columns 606 and rows 608. As seen in FIGS. 6 to 8, a plurality of the faces 430 of each virtual object 420 are made visible to a user during the roll and rotation of objects 420. The axis of rotation of objects 420 may change as they tumble toward their final destination. Virtual objects 420 may be animated to appear to roll or tumble toward the user, before stopping in their predetermined locations. According to some embodiments, virtual objects 420 may bounce against virtual shelves 810 during their roll. According to some embodiments, virtual objects 420 may appear to bounce against the screen of video display unit 104 before coming to rest in their predetermined locations.

Screenshots 600, 700 and 800 also display other game features. For example, a play line indicator 650 is shown on either side of game area 605, showing the total number of active play lines for the current game scenario. For example, in the illustrated embodiment, 243 play lines are active. According to some embodiments, a player may be able to select a sub-set of possible play lines to be the active play lines during a game. Screenshots 600, 700 and 800 also show a progress bar 660, displaying current game information to a user. For example, volume display 662 displays a currently selected volume level for the game. Bet indicator 664 show the number of credits and the corresponding currency amount selected as the bet amount for the current game. In the illustrated embodiment, the bet amount is shown as 5 credits, or 5 cents. Win meter 666 shows a total amount of credits and currency won by the user in the current game. In the illustrated embodiments, the win meter shows that no credits or currency have been won. Credit meter 668 shows the number of credits and corresponding currency that the player has available to play with. In the illustrated embodiment, the player has 2510 credits, or $25.10 in credit. Credit exchange converter 669 shows the credit to currency conversion for the present game. In the illustrated example, 1 credit is shown as being equivalent to 1 cent.

FIG. 8 shows virtual objects 420 in a final rest position as predetermined by processor 202 at step 540 of method 500, as described above with reference to FIG. 5. At this stage, processor 202 may perform step 560 of method 500, by comparing the symbols shown to a pay table stored in memory 204. According to some embodiments, multiple faces 430 of objects 420 are visible when objects 420 are in their final rest position. However, only the front-facing face, being the face randomly selected at step 540 of method 500, may be considered by processor 202 in determining whether a winning combination has occurred.

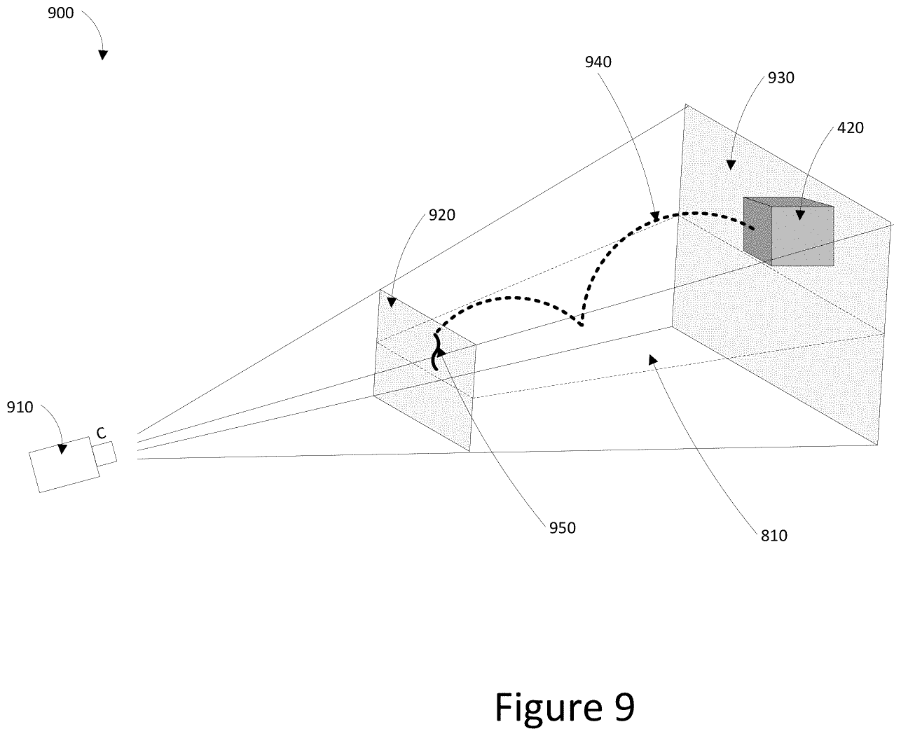

FIG. 9 shows a diagrammatical representation 900 of the movement of a virtual object 420 as animated by gaming machine 100 during step 550 of method 500, as described above with reference to FIG. 5. Representation 900 is shown in a perspective view. However, the movement of object 420 is presented on video display unit 104 in front view, as would be captured by virtual camera 910 at plane 920. Plane 920 represents the field of view that would be captured by virtual camera 910, and can be considered a virtual screen, such that objects located against plane 920 would appear to be right against a screen of video display unit 104 when the animation is displayed on video display unit 104.

Virtual object 420 is initially positioned in line with a plane 930, which is parallel to plane 920. A force is applied to object 420 to cause the object to move from plane 930 toward plane 920 along path 940, indicated by thick dashed lines. Virtual object 420 may interact with one or more virtual barriers during its motion. In the illustrated example, virtual object 420 bounces against virtual shelf 810, the bounds of which are shown in dashed lines. As shown in FIG. 8, a number of virtual shelves 810 may separate rows 608 of virtual objects 420. According to some embodiments, virtual object 420 may bounce against virtual shelf 810 multiple times. Virtual object 420 then bounces against plane 920, causing it to change direction and follow path 950, shown in a thick line, before settling in a final rest position on virtual shelf 810 and against plane 920. This final position is also shown in FIG. 8.

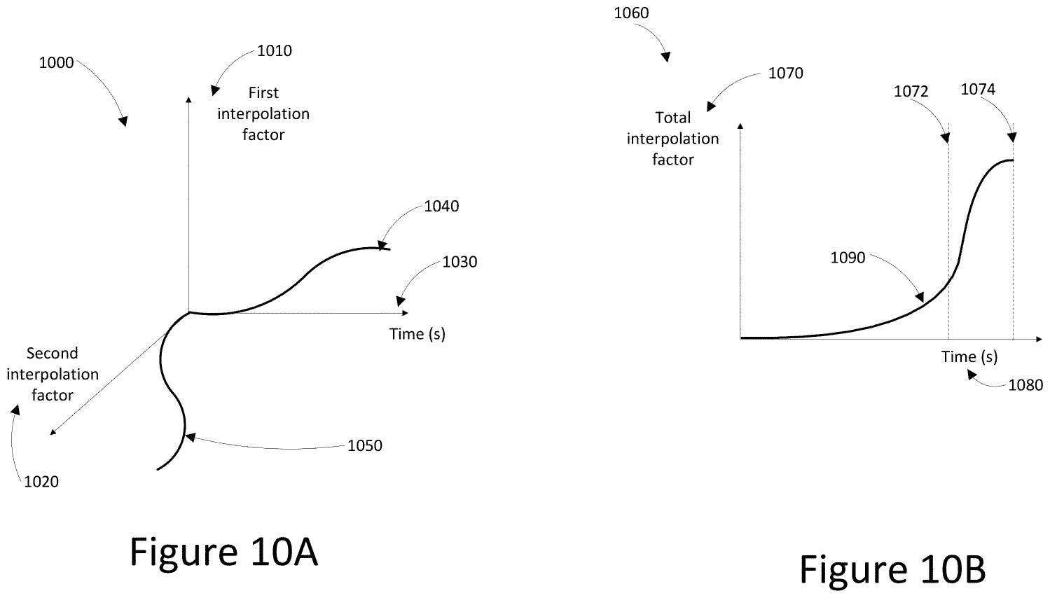

The movement of virtual object 420 may be generated by processor 202 to follow principles of Newtonian motion, and to be affected by gravity. In addition, processor 202 may apply an additional force to virtual object 420, to cause object 420 to land in a predetermined position, with the face 430 pre-selected at step 540 of method 500 being displayed toward plane 920 and toward the user. FIGS. 10A and 10B illustrate graphs showing the application of one or more such interpolation forces.

FIG. 10A shows a graph 1000 having a first axis 1010 reflecting a first interpolation factor, a second axis 1020 reflecting a second interpolation factor, and a third axis 1030 reflecting time in seconds. Line 1040 shows the magnitude of the first interpolation factor over time, while line 1050 shows the magnitude of the second interpolation factor over time. Each of the first and second interpolation factors may be a double inverse cosine force ranging from 0 to 1 and forming a stretched “S” curve. The interpolation factors are combined to produce a final interpolation factor as shown in FIG. 10B. This combination is performed by applying interpolation factor A to the time scale of interpolation factor B, to create the long S shape seen in FIG. 10B. This combination of factors provides a force onto virtual object 420 that imitates a magnetic field created by a magnet sitting in the desired final position of virtual object 420. The force has little effect on object 420 when object 420 is far from the desired final position, and increased exponentially when object 420 nears the final position.

FIG. 10B shows a graph 1060 having a first axis 1070 reflecting a total interpolation factor, and a second axis 1080 reflecting time in seconds. Line 1090 shows the magnitude of the total interpolation factor over time. As described above, this starts small at time=0 seconds, and increases rapidly after the first cosine midpoint of line 1090, indicated by line 1072. According to some embodiments, the first cosine midpoint of line 1090 may coincide with virtual object 420 colliding against plane 920. According to some embodiments, this may occur at time=0.75 seconds. At time=1 second, indicated by line 1074, virtual object 420 comes to rest on virtual shelf 810 and against plane 920 as shown in FIG. 8.

The interpolation factors may be applied to virtual objects 420 in real time, to cause them to appear to naturally land in the orientation pre-determined for them based on the face 430 randomly selected at step 540 of method 500.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of double-randomised virtual object generation, the method comprising:
generating a pre-determined number of virtual pots;
generating a pre-determined number of virtual objects, each virtual object allocated to one of the virtual pots and comprising a pre-determined number of unique faces;
randomly selecting a pre-determined number of virtual objects from the virtual pots;
for each randomly selected virtual object, randomly selecting a face of the virtual object; and
presenting the randomly selected objects on a display, each randomly selected object being oriented to show its randomly selected face.

2. The method of claim 1, further comprising:
comparing the randomly selected faces with a pay table; and
based on the comparison, determining whether a winning event has occurred.

3. The method of claim 1, wherein the randomly selected objects are presented on the display in a grid formation of rows and columns.

4. The method of claim 3, wherein randomly selecting a pre-determined number of virtual objects comprises selecting a non-prime number of virtual objects and assigning each virtual object a predetermined position in the grid.

5. The method of claim 4, wherein randomly selecting a pre-determined number of virtual objects comprises selecting fifteen virtual objects and assigning each virtual object a predetermined position in the grid, the grid comprising five columns and three rows.

6. The method of claim 1, wherein at least one randomly selected object is shown to move into a predetermined position on the display.

7. The method of claim 6, wherein the at least one randomly selected object is shown to bounce against at least one virtual barrier as the object moves into the predetermined position on the display.

8. The method of claim 7, wherein the at least one randomly selected object is shown to bounce against at least one virtual barrier extending along a horizontal plane and at least one virtual barrier extending along a vertical plane as the object moves into the predetermined position on the display.

9. The method of claim 8, wherein the vertical plane is parallel to the plane defined by the display.

10. The method of claim 6, wherein the at least one object rotates as the object moves into the predetermined position on the display.

11. The method of claim 10, wherein an axis of rotation of the at least one object changes as the object moves into the predetermined position on the display.

12. The method of claim 1, wherein at least one randomly selected object is subject to an increasing virtual interpolation force as the object moves toward the predetermined position on the display, wherein the interpolation force causes the object to rotate into a position whereby the randomly selected face is presented toward a viewer of the display when the object moves into the predetermined position on the display.

13. The method of claim 1, whereby each randomly selected object has six faces.

14. The method of claim 1, wherein each of the randomly selected faces displays at least one of a letter, numeral, or image.

15. A gaming machine comprising:
memory storing program code; and
a processor configured to access the memory and execute the program code;
wherein, when executing the program code, the processor is caused to perform a method, the method comprising:
generating a pre-determined number of virtual pots;
generating a pre-determined number of virtual objects, each virtual object allocated to one of the virtual pots and comprising a pre-determined number of unique faces;
randomly selecting a pre-determined number of virtual objects from the virtual pots;
for each randomly selected virtual object, randomly selecting a face of the virtual object; and
presenting the randomly selected objects on a display, each randomly selected object being oriented to show its randomly selected face.

16. The gaming machine of claim 15, further comprising a credit input mechanism configured to accept credit from a user to initiate the performance of the method.

17. The gaming machine of claim 15, further comprising a payout mechanism configured to output credit to a user when a winning combination is determined.

18. A method of controlling motion of a virtual object, the method comprising:
determining a desired final orientation for a virtual object;
positioning the virtual object at a pre-determined starting position;
applying a virtual force to the object to propel it toward a pre-determined finishing position;
applying an interpolation factor to the virtual object, the interpolation factor increasing over time, wherein the interpolation factor causes a pulling of the virtual object into the desired final orientation when the object reaches the pre-determined finishing position.

19. The method of claim 18, wherein the virtual force causes a rotation of the virtual object.

20. The method of claim 19, wherein an axis of rotation of the virtual object changes over time.
